(19) United States
(12) Patent Application Publication
(10) Pub. No.: US 2014/0183215 A1
(43) Pub. Date: Jul. 3, 2014

(54) VENDING MACHINE WITH GOODS CHANNEL

(71) Applicant: HON HAI PRECISION INDUSTRY CO., LTD., New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 14/014,639

(22) Filed: Aug. 30, 2013

(30) Foreign Application Priority Data
Dec. 27, 2012 (CN) 2012105774796

(51) Int. Cl. G07F 11/00

(52) U.S. Cl. CPC G07F 11/005
USPC 221/251

(57) ABSTRACT

A vending machine allowing the restocking of goods without the detachment or use of any fasteners includes a goods rack, a positioning piece, and a restricting strip. The goods rack defines a goods channel and includes a flange. An engaging piece comprising a wide piece and a narrow piece is formed on the flange. The positioning piece defines a slot comprising a wide portion and a narrow portion and a receiving hole. The restricting strip includes a pivoting shaft. The engaging piece is inserted into the wide portion. The positioning piece slides on the flange to insert the narrow piece into the narrow portion. The wide piece blocks the positioning piece. The pivoting shaft housed in the receiving hole pivotally mounts the restricting strip on the goods rack to cover the goods channel.

### BACKGROUND

1. Technical Field

The present disclosure generally relates to vending machines, and particularly to a vending machine with goods channels.

2. Description of Related Art

Vending machines have goods channels for accommodating goods for sale. After all of the goods in the goods channels are delivered, the goods channels need to be disassembled to place new goods in the goods channels. However, conventional goods channels are closed by screws, which is inconvenient for disassembling the goods channels.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an embodiment of a vending machine.

FIG. 2 is an enlarged view of the circle II of FIG. 1.

FIG. 3 is an assembled and isometric view of the vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

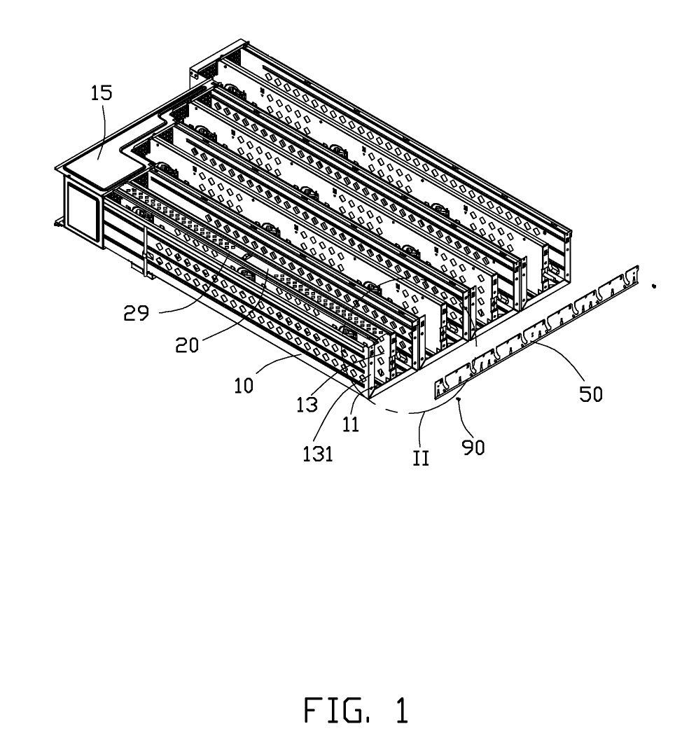

FIG. 1 shows an embodiment of goods channels of a vending machine which includes a goods rack 10 for receiving goods, a plurality of restricting strips 20, and a positioning piece 50.

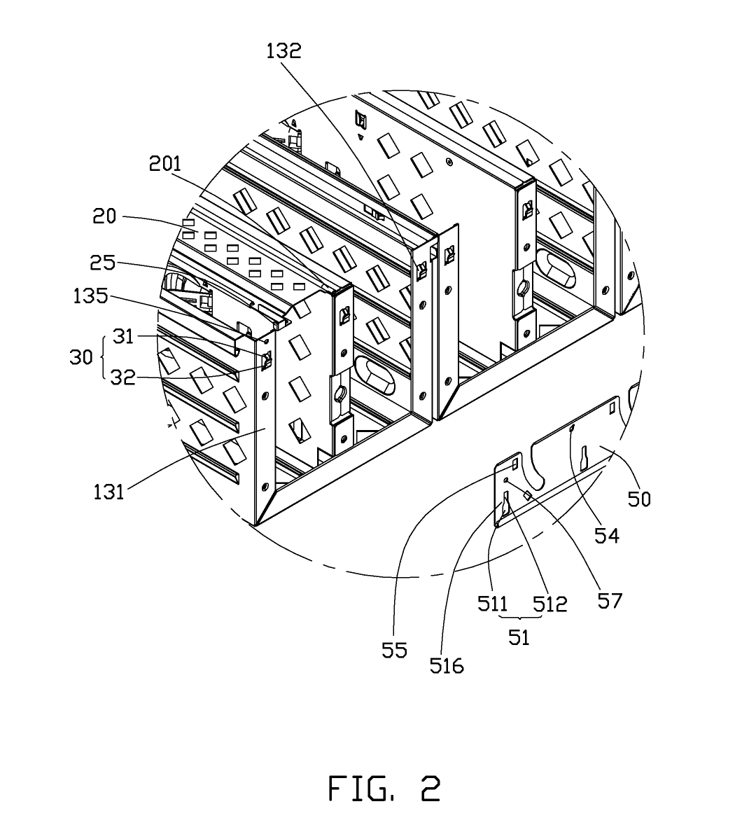

Referring to FIGS. 1 and 2, the goods rack 10 includes a bottom plate 11 and a plurality of parallel side plates 131 perpendicularly connected to the bottom plate 11. A goods channel 29 is defined between two adjacent side plates 131. A front end of the side plate 131 is bent to form a flange 131. The flange 131 defines a through opening 132. An engaging piece 30 is connected between a top edge and a bottom edge of the through opening 132. The engaging piece 30 includes a narrow piece 31 and a wide piece 32. The narrow piece 31 is connected to the top edge of the through opening 132 and extends downwards and is aslant. The wide piece 32 is connected to the bottom edge of the through opening 132 and extends upwards and also slants, to connect to the narrow piece 31. The flange 131 further defines a first securing hole 135. A connection plate 15 is connected to rear ends of the plurality of side plates 131. The connection plate 15 defines a plurality of pivot holes (not shown), and each of the plurality of pivot holes corresponds to a goods channel 29.

Each of the plurality of restricting strips 20 is adapted to be rotatably mounted on the side plates 13 to cover a goods channel 29. Opposite ends of the restricting strip 20 forms a pair of pivoting shafts 201. A clasp 25 is formed on the restricting strip 20.

The positioning piece 50 defines a plurality of slots 51. Each slot 51 includes a wide portion 511 and a narrow portion 512. The wide portion 511 communicates with the narrow portion 512. The wide portion 511 is located below the narrow portion 512. A shoulder portion 516 is formed on a connection portion of the wide portion 511 and the narrow portion 512. A width of wide portion 511 is larger than a width of the wide piece 32. A width of the narrow portion 512 is larger than a width of the narrow piece 31 but smaller than the width of the wide piece 32. The positioning piece 50 defines a plurality of receiving holes 54, a plurality of engaging holes 55, and a plurality of second securing holes 57.

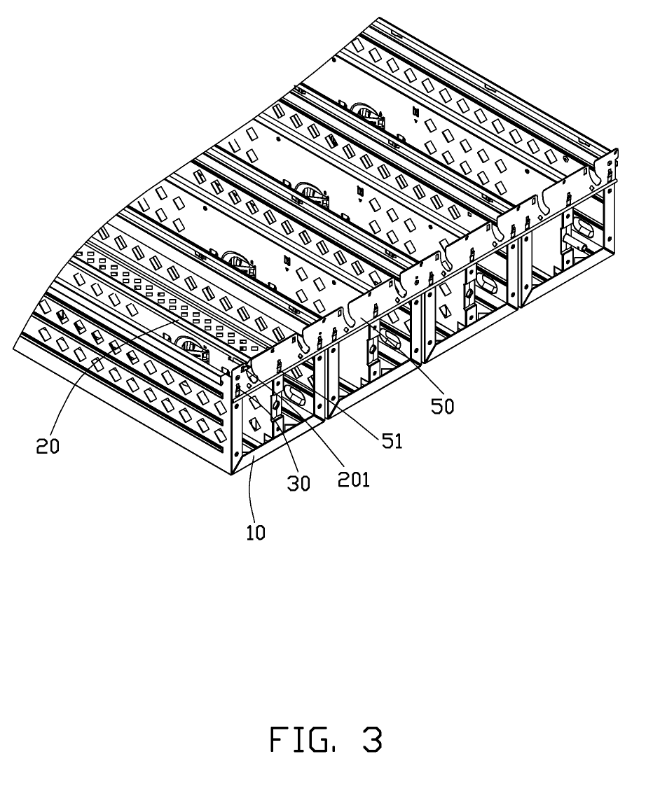

Referring to FIGS. 1 to 3, in assembly, a pivoting shaft 201 of the restricting strip 20 is inserted in a pivot hole of the connection plate 15. The slot 51 of the positioning piece 50 is aligned to the engaging piece 30 of the goods rack 10. The engaging piece 30 is inserted in the wide portion 511 of the slot 51. Then, the engaging piece 30 slides down to have the narrow piece 31 slide in the narrow portion 512 of the slot 51. The shoulder portion 516 is located on a connection portion of the wide piece 32 and the flange 131. The wide piece 32 blocks opposite edges of the narrow portion 512. At this position, the second securing hole 57 of the positioning piece 50 is aligned to the first securing hole 135 of the goods rack 10. A rivet 90 is secured in the first securing hole 135 and the second securing hole 57 to mount the positioning piece 50 on the goods rack 10. Another pivoting shaft 201 of the restricting strip 20 is inserted in the receiving hole 54 to pivotally mount the restricting strip 201 on the goods rack 10. The clasp 25 of the restricting strip 20 is engaged in the engaging hole 55 to secure the restricting strip 20 on the goods rack 10. At this position, the restricting strip 201 will cover a goods channel 29 of the goods rack 10.

When goods needs to be placed in the goods channels 29 of the goods rack 10, the clasp 25 is disengaged from engaging hole 55. Then, the restricting strip 20 is simply rotated to open the good channels 29. Thereby, goods can be placed in the goods channels 29.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A vending machine, comprising:
a goods rack comprising a goods channel, a flange, an engaging piece formed on the flange, the engaging piece comprising a wide piece and a narrow piece connected to the wide piece;
a positioning piece comprising a slot and a receiving hole, the slot comprising a wide portion and a narrow portion, a width of the wide portion being smaller than a width of the wide piece; and
a restricting strip comprising a pivoting shaft;
wherein the engaging piece is inserted into the wide portion of the slot, the positioning piece slides on the flange to have the narrow piece of the engaging piece inserted into the narrow portion of the slot, the wide piece blocks the positioning piece adjacent to the narrow portion, and the pivoting shaft is inserted into the receiving hole to pivotally mount the restricting strip on the goods rack to cover the goods channel.

2. The vending machine of claim 1, wherein the restricting strip comprises a clasp, the positioning piece defines an engaging hole, and the clasp is configured to engage in the engaging hole to mount the restricting strip on the positioning piece.

3. The vending machine of claim 1, wherein a shoulder portion is formed on a connection portion of the narrow portion and the wide portion, and the shoulder portion is located on a connection portion of the wide piece and the flange.

4. The vending machine of claim 3, wherein the narrow portion is located above the wide portion, and the positioning piece slides downwardly by gravity of the positioning piece to have the shoulder portion located on the connection portion of the wide piece and the flange.

5. The vending machine of claim 1, wherein the flange defines a through opening, the engaging piece is connected between a top edge and a bottom edge of the through opening.

6. The vending machine of claim 5, wherein the narrow piece is connected to the top edge of the through opening and extends downwardly and aslant, the wide piece is connected to the bottom edge of the through opening and extends upwardly and aslant to connect the narrow piece.

7. The vending machine of claim 1, wherein the goods rack comprises a bottom plate and two parallel side plates perpendicularly connected to the bottom plate, and the goods channel is defined between the two parallel side plates.

8. A vending machine, comprising:
a goods rack comprising a goods channel, the goods rack comprising a flange, an engaging piece formed on the flange;
a positioning piece defining a slot and a receiving hole; and
a restricting strip comprising a pivoting shaft;
wherein the engaging piece is inserted in the slot to mount the positioning piece on the goods rack, and the pivoting shaft is inserted in the receiving hole to pivotally mount the restricting strip on the goods rack to cover the goods channel.

9. The vending machine of claim 8, wherein the restricting strip comprises a clasp, the positioning piece defines an engaging hole, and the clasp is configured to engage in the engaging hole to mount the restricting strip on the positioning piece.

10. The vending machine of claim 8, wherein the engaging piece comprises a wide piece and a narrow piece connected to the wide piece, the slot comprises a wide portion and a narrow portion, a width of the wide portion is smaller than a width of the wide piece, the engaging piece is inserted in the wide portion of the slot, the positioning piece slides on the flange to have the narrow piece of the engaging piece inserted in the narrow portion of the slot, the wide piece blocks the positioning piece adjacent the narrow portion to mount the positioning piece on the goods rack.

11. The vending machine of claim 10, wherein a shoulder portion is formed on a connection portion of the narrow portion and the wide portion, and the shoulder portion is located on a connection portion of the wide piece and the flange.

12. The vending machine of claim 11, wherein the narrow portion is located above the wide portion, and the positioning piece slides downwardly by gravity of the positioning piece to have the shoulder portion located on the connection portion of the wide piece and the flange.

13. The vending machine of claim 10, wherein the flange defines a through opening, the engaging piece is connected between a top edge and a bottom edge of the through opening.

14. The vending machine of claim 13, wherein the narrow piece is connected to the top edge of the through opening and extends downwardly and aslant, the wide piece is connected to the bottom edge of the through opening and extends upwardly and aslant to connect the narrow piece.

15. The vending machine of claim 8, wherein the goods rack comprises a bottom plate and two parallel side plates perpendicularly connected to the bottom plate, and the goods channel is defined between the two parallel side plates.
